(19) United States
(12) Patent Application Publication
(10) Pub. No.: US 2006/0088068 A1
(43) Pub. Date: Apr. 27, 2006

(54) Low noise swept wavelength laser system and method

(75) Inventors: Thomas Farrell, Dublin (IE); David McDonald, Dublin (IE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Intune Technologies, Dublin (IE)

(21) Appl. No.: 11/251,117

(22) Filed: Oct. 13, 2005

Related U.S. Application Data
(60) Provisional application No. 60/618,264, filed on Oct. 13, 2004.

(51) Int. Cl. H01S 3/13

(52) U.S. Cl. 372/29.02

(57) ABSTRACT

The invention provides a swept wavelength laser system comprising: a module providing a laser source with an optical output where the laser wavelength sweeps a wavelength range of the laser source with low wavelength noise at a sweep frequency rate; and a real-time high speed single measurement of an optical artefact over a single wavelength sweep wherein the laser source is optimized for low noise operation.

### RELATED APPLICATIONS

The present patent application claims priority under 35 U.S.C. § 119(e) to U.S. Provisional Patent Application Ser. No. 60/618,264, which was filed Oct. 13, 2004. The full disclosure of U.S. Provisional Patent Application Ser. No. 60/618,264 is incorporated herein by reference.

### FIELD

This invention relates to a low noise swept wavelength system, specifically where the system is implemented to provide a laser source in a manner which reduces the noise in the optical wavelength of the system while performing a wavelength sweep.

### BACKGROUND

Typically, laser systems that have been employed for wavelength sweeping of lasers are implemented by current control of electronic controlled lasers or movement of a mirror in an external cavity laser. It can also be performed by temperature control. The rate of sweep of such systems is typically small and modulation rates low (<1 MHz).

Semiconductor lasers are well known in the art, a treatment of which can be found in reference texts such as that referenced in ‘Principles of Lasers, O. Svelto, 3rd ed. Plenum Press (1989). Other systems that use fast sweeping of a laser are used for gas sensing applications among others. Here a light beam with modulated wavelength is passed through a gas and absorption lines are detected.

The problem with these systems is that they use an averaging means at the receiver or in subsequent processing to reduce noise effects in the laser which results in poor measurements.

US Patent Publication No. 2004/0190148 ‘Clark et al’ discloses a method and system for performing swept-wavelength measurements within an optical system incorporating a reference resonator provides improved operation in resonator-enhanced optical measurement and data storage and retrieval systems. The system includes an illumination subsystem, an illumination coupler for producing a measurement beam and a reference beam from an output of the optical illumination source, a reference resonator for receiving the reference beam, a measurement resonator for receiving the measurement beam, at least two detectors, one optically coupled to the reference resonator and one optically coupled to the measurement resonator, and a time-domain measurement system coupled to the detectors for comparing detected optical signals received from the resonators. The detected signal from the reference resonator is used to compensate or detect variations in the wavelength of the illumination system, improving the resolution and accuracy of the measurement provided by the measurement resonator. However the method and system disclosed by Clark does not optimize the laser source for low noise.

Therefore, it would be beneficial to provide a swept wavelength source optimized with low noise for precise measurement of wavelength dependent effects.

### SUMMARY

The present invention, as set out in the appended claims, provides a method and system of operating a laser to generate a low noise wavelength sweep. The invention provides a swept wavelength laser system comprising a module providing a laser source with an optical output where the laser wavelength sweeps a wavelength range with low wavelength noise at a sweep frequency rate; and a real-time high speed single measurement of an optical artefact over a single wavelength sweep wherein the laser source is optimized for low noise operation Ideally the single wavelength sweep is a sinusoidal, sawtooth or triangular shape. The waveform shape is further filtered or processed by a processing element to reduce changes in the output wavelength and reduce the effect of output power variations. The low wavelength noise results in reduced timing indeterminacy of said optical artefact illuminated by said laser source.

Ideally, the sweep frequency rate may be chosen so that the 1/f optical noise in the laser is minimized. As the sweep frequency is increased the measurement time for a single wavelength sweep decreases and hence the noise power integrated over this time reduces. As this noise element drops at a rate of 1/f by using higher sweep speeds the portion of the 1/f noise that is integrated is reduced and the impact of this noise on a measurement system is greatly reduced. For typical DFB lasers when the sweep speed approaches MHz levels the effects of 1/f noise is greatly reduced and can become insignificant to other noise sources in the system.

In another embodiment the sweep frequency rate can be chosen so that the bandwidth of a receiver is minimized so that the integrated noise on the receiver is minimized. As the lorentzian noise of the laser is flat with frequency response, increasing the sweep rate results in a large bandwidth requirement on a measurement system, i.e. if a sweep rate of 1 MHz is used and a bandwidth of 100 MHz is required, doubling the sweep rate will also double the bandwidth requirements, which in turn doubles the receiver noise power due to lorentzian noise.

In a further embodiment the sweep frequency rate is chosen so that FM efficiency is maximized while simultaneously minimizing the power modulation of the output. The FM efficiency of the laser has two regimes, thermal tuning where changing the injected current to the device will change the power dissipated in the device and hence change the material refractive index and the laser wavelength. This thermal effect is strongest at low frequencies and at high frequencies the thermal effects will average out due to the thermal time constant of the material. The second effect is carrier induced refractive index changes. Therefore by changing the current in the laser the refractive index will change and hence the wavelength of the laser. This effect is constant with frequency.

The thermal and carrier induced refractive index effects of the laser are of opposite sign which means that at certain frequencies they effectively cancel each other out, so by selecting a sweep rate of the laser in this region will minimize the tuning efficiency of the laser, so by selecting a sweep rate high or lower than this cancellation point the efficiency of the laser tuning is maximized and the power variation required to achieve a particular tuning range of the laser is reduced. In typical lasers the frequencies where the thermal and carrier induced refractive index changes cancel is in the region of 100 KHz to 10 MHz.

Preferably the laser module is used as a wavelength swept source in an optical system where the approximately linear part of the sweep is used to measure said optical artefact.

The optical artefact is any one or any combination of the following: a) Fabry Perot Etalon, b) Gas absorption line, c) Fibre bragg grating, d) an interferometer, e) an optical filter.

Optionally a voltage or a current drive signal is applied to the laser.

In another embodiment the temperature of the laser is controlled to provide adjustment of the laser sweep wavelength. A bias point of the laser can be chosen to minimize the output power variation of the laser.

Ideally a reference etalon is used to identify a reference wavelength in the sweep. The reference wavelength is selected so that it is in the center of the wavelength sweep or the module can be configured to select a reference wavelength from a test etalon.

In a further embodiment output power of the laser is normalized by used of a variable attenuator or an optical modulator.

There is also provided a computer program comprising program instructions for causing a computer program to carry out the above method which may be embodied on a record medium, carrier signal or read-only memory.

These as well as other aspects and advantages will become apparent to those of ordinary skill in the art by reading the following detailed description, with reference where appropriate to the accompanying drawings. Further, it is understood that this summary is merely an example and is not intended to limit the scope of the invention as claimed.

### BRIEF DESCRIPTION OF THE DRAWINGS

These and other features of the present invention will better understood with reference to the following drawings in which:

FIG. 1 shows an embodiment of the invention

FIG. 2 shows a plot of the wavelength output of the invention.

FIG. 3 shows a frequency plot of the optical noise of the laser which makes up the linewidth of the laser.

FIG. 4 shows the integrated noise on a receiver as a function of the sweep frequency of the laser.

FIG. 5 shows a schematic of a DFB laser.

FIG. 6 shows a typical FM efficiency response of a DFB laser.

FIG. 7 shows a system to measure the wavelength sweep of the laser.

FIG. 8 shows a wavelength measurement of the laser performed by the system shown in FIG. 7.

FIG. 9 shows a plot of the standard deviation of the time between two etalons showing the effects of jitter in the sweep and also an optical cavity in the system.

### DETAILED DESCRIPTION

The invention will now be described with reference to exemplary embodiments thereof and it will be appreciated that it is not intended to limit the application or methodology to any specific example.

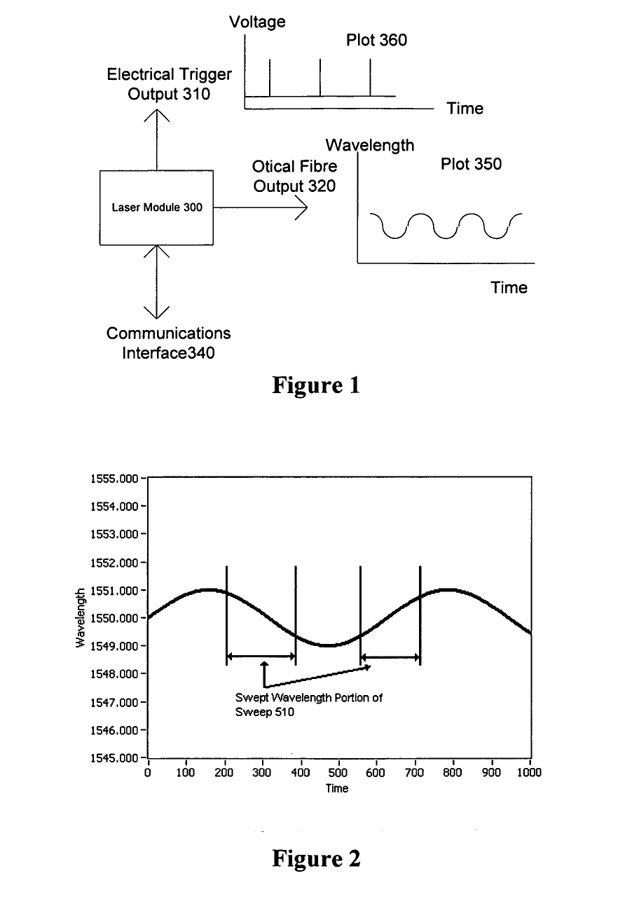

Referring to FIG. 1, a laser module 300 according to the present invention is shown. The laser module has an electrical output trigger 310 which triggers a wavelength sweep. A plot of the trigger output 360 is shown. The laser module has an optical fibre output 320 whose wavelength plot 350 is also shown. The module also has an electrical communications input 340 which may be used to control the laser module. The output of the laser provides an optical output where the wavelength is swept over a specified range. This wavelength sweep is performed at rates which ensure low noise of the output of the laser. Care is taken of the sweep rate to ensure the minimum noise from the laser, either electrical noise into the laser or optical noise from the line width of the laser. The module 30 is designed to be used in system which requires the precise wavelength measurement of optical artefacts such as fabry perot etalons. It will be appreciated that the optical artefact can be any one of the following: a. Fabry Perot Etalon, b. Gas absorption line, c. Fibre bragg grating, d. an interferometer, e. an optical filter, the operation of each in the context of the present invention is described in more detail below.

A difference between the module of the present invention is that prior art systems use an averaging means at the receiver or in subsequent processing to reduce noise effects in the laser and are not performed in a single shot real time measurement.

The present invention provides a wavelength sweep function which is typically sinusoidal as shown in FIG. 2. The usable parts of the wavelength sweep 510 are shown in this plot also. The laser module is designed for single shot or real time measurements, where the usable part of the wavelength sweep can be used to obtain a single measurement. This means that while the laser sweeps over the section 510 a complete measurement can be performed in real time. No other parts of the wavelength sweep are required.

Also the present invention enables measurement of the wavelength sweep and means to monitor the noise of the system. Also the module includes means to adjust the wavelength range covered by the sweep by means of temperature tuning of the laser. Means are also given to identify back reflections in the system which can cause degradation in the performance of the system.

The laser is driven by a voltage or current signals into the active media, for example a DFB laser has an electrical contact direct to the active media and by applying a voltage across or passing current through the device, to generate light. The use of a very precise low noise drive current will reduce the effects of noise in the system as this drive voltage corresponds directly to the output wavelength and power of the laser. Rather than using a linear drive current, a sine wave modulation enables very high filtering of the modulation using a high Q filter to remove any unwanted noise in the signal applied to the laser can be used. Then the approximately linear part of the sine wave can be used for measurement.

By increasing the modulation frequency the noise in the laser can be reduced over the sweep interval. The linewidth (caused mostly by phase noise) of a laser has two components:

1. 1/f noise

2. Lorentzian noise

The 1/f noise reduces with frequency, so that the laser wavelength will vary much more over longer time frames than over shorter time frames. The lorentzian noise is a white noise source with equal power distribution with frequency. Details of this can be found in Journal of Light Wave Technology, L Mercer, vol. 9, 1991, pages 485-493. By selecting the correct frequency window to sweep the laser, and combined with the receiver bandwidth (which must be related to the sweep rate) the noise on the receiver due to linewidth can be minimised.

The wavelength range of the laser sweep can be adjusted independently of the laser drive by using temperature control of the laser. This can be used as a lock in for the laser sweep, i.e., by measuring a reference etalon per sweep, the temperature of the laser can be adjusted so that the reference is in a predetermined part of the sweep, and can be locked to that position in the sweep.

The selection of the bias point for the laser is also significant as effects such as spatial hole burning in the laser will tend to broaden the linewidth of the source and hence the noise in the laser sweep, and the bias point should not be too low as laser linewidth decreases with increased output power, which is proportional to the laser drive, therefore the laser drive current should be picked so that it is before spatial hole burning occurs to broaden the linewidth but with as much output power as possible before that point.

The use of voltage sources, as opposed to current sources, for reduction of the effects of shot noise due to the driving electronics is also significant. Voltage source driving of the laser is a means of further reducing the shot noise effects of the more traditional current source driving means.

A further means of reducing the onset of line width increase, and simultaneously increasing the wavelength tuning range possible is through the use of multi-contact DFB lasers, such as three section devices. This format of device prolongs the output power level at which spatial hole burning becomes dominant. Thus larger output powers can be reached before line width broadening occurs.

The method of sweeping the laser should be performed so that the drive signal has very low noise. An exemplary method to perform this is to use a sinusoidal waveform that can be filter using commercial high Q filters. The advantage of this technique is that as it is using the fundamental frequency of an oscillator such as a crystal, the purity of the modulation is very high and jitter (or similarly sweep rate variation) will be very low, and hence the current or voltage drive will have very low noise and be very repeatable and hence the output of the laser will have lower noise and the wavelength sweep will be very uniform and repeatable. Other waveforms such as triangle or saw tooth can also be used but filtering can be more difficult.

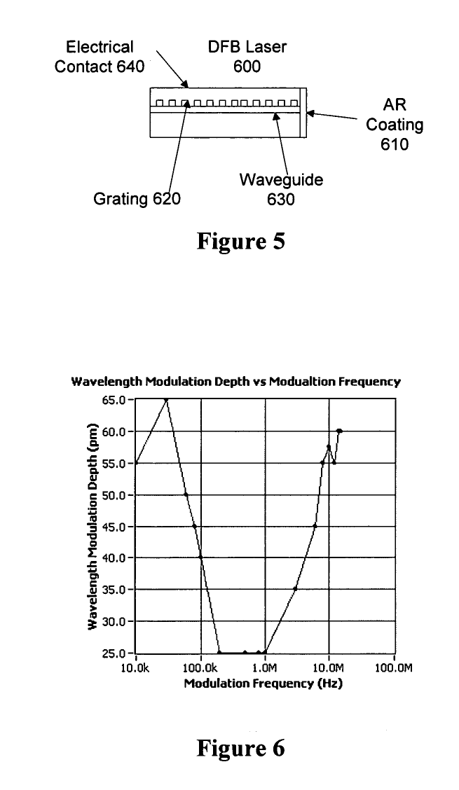

For a DFB laser 600 shown in FIG. 5 that typically consists of a waveguide 630 which guides the optical light generated by the device, a grating 620 that provides a distributed reflection at a particular wavelength and acts as an optical resonator. An anti-reflective coating 610 is typically used on the output facet of the laser to maximize the output power of the laser by minimizing the light reflected back into the device.

There are two main external control elements of the laser, the temperature of the laser, and the current or voltage applied to the laser. The temperature of the laser will vary the wavelength of the laser due to the refractive index of the laser dependence on temperature which in effect changes the resonance wavelength of the grating and hence the laser wavelength. The current or voltage applied to the laser will change the output power of the laser. The current or voltage will also change the wavelength of the laser from two effects, the first effect is the temperature of the laser will vary due to the amount of power entered into the chip, most of this power is generated as heat, and the rest of it is generated as light emitted from the laser. The second effect is due to the refractive index of the laser dependence on the current in the laser material which changes the resonance wavelength of the grating and hence the wavelength.

The heat generated in the laser has a particular time constant which means that the wavelength changes due to current or voltage changes in the laser can only follow the current or voltage at a certain rate. This time constant is typically such that if the laser current or voltage is varying at rates below 100 KHz, the tracking between wavelength and current is good, and at higher frequencies the wavelength variation will be low pass filtered out.

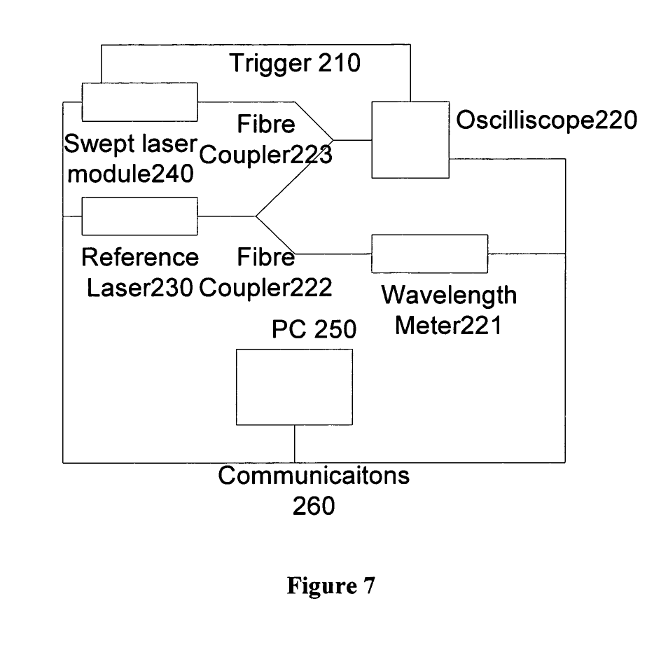

The refractive index changes due to its dependence on the current in the laser has a much faster time constant and also has an opposite sign and is also a smaller effect so that the effects of both the thermal and refractive index changes can be seen in FIG. 7.

By applying a sinusoidal modulation to the laser at a particular bias point, the FM efficiency can be plotted. FIG. 6 shows the peak to peak wavelength modulation caused by a fixed voltage modulation on the laser and is proportional to the FM efficiency. As can be seen in the graph, the wavelength modulation starts off at about 60 pm for modulation rates <100 KHz, and is falling with increasing frequency, at 200 KHz it flattens out, and this is due to the fall off in the thermal modulation due to the time constant of this effect. This does not fall to zero as the refractive index variations due to current are causing wavelength modulation also. While this modulation is of the opposite sign to the thermal, there is a phase difference between them, (considered as a time lag between the current and the thermal modulation due to the time constant) so they do not cancel out completely at any modulation frequency. At 1 MHz the wavelength modulation starts to increase again where the wavelength modulation due to the free carrier induced refractive index changes is now becoming larger than the thermal wavelength modulation. This continues until the thermal wavelength modulation becomes insignificant at about 10 MHz and all that is left is the wavelength modulation due to the refractive index dependence on the current/voltage.

The operating point of the laser should be picked so that the FM efficiency of the laser is large enough to provide the wavelength tuning required while not causing to large a modulation in the output power of the laser, i.e., if a laser wavelength modulation is required of 40 pm, the power modulation of the laser as a function of frequency is constant over the frequency range which means that the optimum operating point of the laser is 10 MHz. This operating point of the laser means that there is a minimum of power variation in the laser due to the current/voltage modulation and that the sweep rate of the laser is no faster than it is required to be. The penalty in operating the laser faster than required is that the electronics on the receiver will need to operate faster and will cost more, also the bandwidth of the receiver needs to be higher and will therefore allow more noise through.

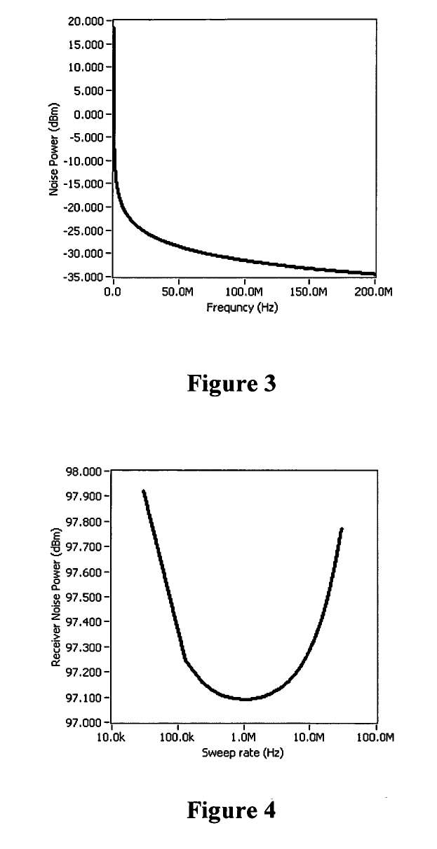

The modulation frequency of the laser or sweep rate also needs to be selected carefully. As there are two components to the line width of the laser, the 1/f and the Lorentzian contributions, careful selection of the operating point of the laser will limit the amount of this noise. FIG. 3 shows a plot for the combined noise in the laser as a function of frequency. This is a combination of the 1/f and the Lorentzian noise. Typically for an etalon of reasonable finesse the receiver bandwidth will have to be from the sweep rate to a couple of harmonics of this (to obtain the etalon response to the correct finesse), therefore the receiver noise is the integrated noise from the sweep rate frequency to a multiple of the sweep rate. In the case where this multiple is 4, the receiver noise power is plotted as a function of the sweep rate in FIG. 4. As can be seen there is a minimum received noise power where the linewidth makes its smallest contribution of noise to the system. This is where the laser should be operated at. The laser can be biased further away from the min if required by the system, i.e., if faster or slower rates are required, with a penalty in the noise. This penalty is much more significant for lower frequencies than higher frequencies.

Means to measure the peak to peak wavelength modulation of the laser are also required especially at high modulation rates. The system includes means to measure this quantity and is detailed below.

By using a system as shown in FIG. 7, the wavelength of the laser for any specific time can be measured. By selecting a wavelength for the reference laser 230 which can be monitored using a wavelength meter 221, then combining the output of the reference laser 230 with the swept laser module 240 by means of a coupler 223 and sending the combined light signal to a photodiode and to an oscilloscope 220, the measurement can be performed. This is normally controlled by a PC 250 and communications paths 260 to all the instruments and lasers.

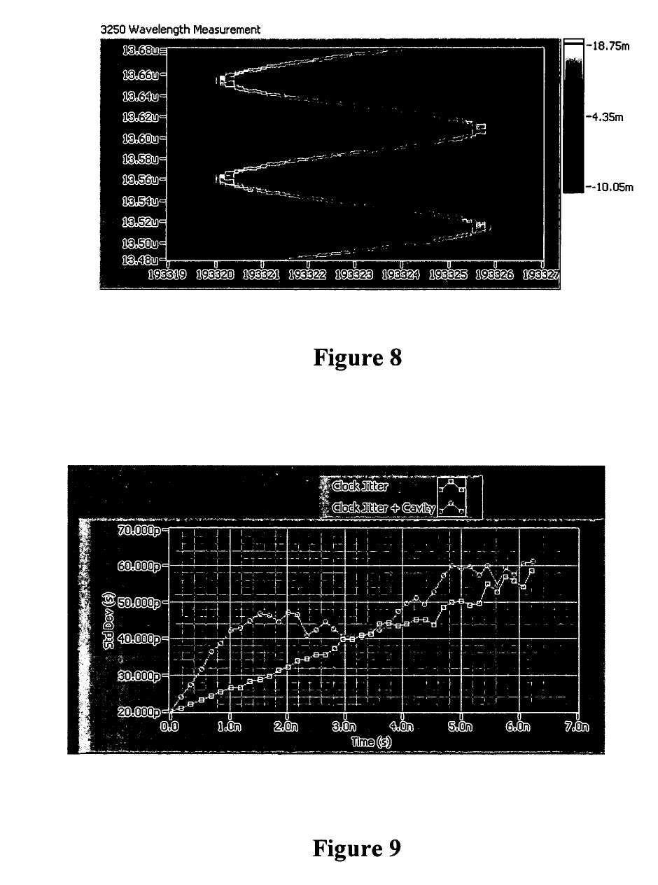

By selecting a wavelength and measuring the response on the oscilloscope, when the two wavelengths are within the bandwidth of the oscilloscope a beat signal or mixing signal will be detected which is the frequency difference between the two laser outputs. By selecting a small bandwidth the wavelength resolution becomes this bandwidth, and typical <100 MHz is used. When the reference laser is moved to another wavelength a beat is obtained when the two lasers are within 100 MHz of each other and therefore the time the laser is at each wavelength can be obtained. An example of this is shown in FIG. 8.

Another method to determine the wavelength sweep of the laser is to use an interferometer where the number of periods obtained between the triggers defines the wavelength range where a period equals a free spectral range of the interferometer. The FSR can be measured statically using standard techniques or can be calculated by determining the path difference between the two arms. The interferometer when used in the above regime differs from normal operation as the wavelength of the swept laser is varying faster than the path delay time and hence it is a mix of two different wavelengths. This has the effect of removing the interferometers absolute wavelength accuracy and the interferometer is used to obtain a differential signal on the wavelength sweep, in other words the time between periods is proportional to the sweep rate of the laser.

Another technique is to use a fabry perot etalon with small FSR and count the number of etalon peaks during a sweep. When the FSR is known the wavelength range can be calculated.

Any type of reflection in the optical system to be tested with the laser module will cause additional noise in the system. FIG. 9 shows the results from a system where two etalons peaks are measured using the swept wavelength source. The time between the two peaks is measured over a large number of sweeps and the standard deviation is obtained on the time difference. If this is repeated for different wavelength differences between the two etalons the plot shown in FIG. 8 is obtained. The x-axis of the plot is the time between the two etalons in nanoseconds and the y-axis is the standard deviation of the time between the two etalon peaks over a large number of scans. As can be seen at a time deference of 0 ns there is a standard deviation of 20 ps which is due to the linewidth of the laser. Two plots are shown. The first is if there is just a jitter in the sweep rate, i.e., the first sweep takes 100 ns, the second 101 ns, the third 99 ns, etc. This corresponds to a difference in the rate of tuning of the laser and, hence, there is a linear relationship between the standard deviation of the time between the two peaks and the time between the two peaks. If there is an optical cavity in the system the standard deviation has a series of humps, which shows increase standard deviation due to the cavity. The peak of the hump which in this case is at time 1.5 ns corresponds to the length of the cavity set up in the optical system.

It should also be noted that there may be a phase difference between the wavelength modulation and the power modulation. This can be optimized by selection of the correct modulation frequency. This phase difference is due to the changing nature of the wavelength modulation due to the thermal and carrier induced effects on wavelength of the device have opposite sign. At low frequency modulation the thermal dominates, while at high frequency the carrier induced refractive index change dominates. In between there is a 180 degree phase shift in the wavelength modulation. It is important that the output power is at an acceptable level during the usable part of the wavelength sweep.

It will be appreciated that other waveforms can be used other than a sine wave, such as triangle and saw-tooth to provide a larger linear modulation. The waveforms require careful manipulation to generate low noise and stable operation and can only equal the performance of a sine wave, and in practice will have more noise as to filter and reduce noise in the signal is more complex. Also with the phase difference between power and wavelength modulation, care is needed to correctly filter the edges so that large discontinuities on the voltage or current drive of the laser are not used. Certain areas of the wavelength tuning are not used as shown in FIG. 2 but large changes in optical power can occur in areas of the wavelength tuning used due to phase differences in the output power and wavelength modulation of the laser.

In another embodiment of the laser it can be combined with a variable attenuator or modulator where a complementary signal is sent to the attenuator or modulator to compensate for the power modulation of the laser due to the current or voltage modulation applied to the laser. This has the effect of reducing and possible canceling the power variation while leaving the wavelength modulation unchanged. This has the advantage that the output power from the modulator or attenuator is constant and the wavelength modulation effects can be observed without calibration for optical power.

It will be appreciated that the present invention provides an efficient manner to effectively compensate for degradation in performance of a laser diode. This is achieved by monitoring the output power of the laser and adjusting the drive voltage or current to compensate. Also wavelength modulation can be compensated by increasing the modulation voltage or current. This can be measured by use of an integrated wavelength locker. Although it has been described with reference to an exemplary embodiment, it will be appreciated that it is not intended to limit the present specification in any manner except as may be necessary in the light of the appended claims.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g., CD ROM, or magnetic recording medium, e.g., a floppy disk or hard disk. The carrier may be an electrical or optical signal which may be transmitted via an electrical or an optical cable or by radio or other means.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The invention is not limited to the embodiments hereinbefore described but may be varied in both construction and detail.

We claim:

1. A swept wavelength laser system, comprising in combination:
(a) a module providing a laser source with an optical output where a laser wavelength sweeps a wavelength range of the laser source with low wavelength noise at a sweep frequency rate; and
(b) a real-time high speed single measurement of an optical artefact over a single wavelength sweep, wherein the laser source is optimized for low noise operation.

2. The swept wavelength laser as claimed in claim 1, wherein the single wavelength sweep is a waveform shape selected from the group consisting of a sinusoidal shape, a sawtooth shape, and a triangular shape.

3. The swept wavelength laser as claimed in claim 2, wherein the waveform shape is processed by a processing element to reduce changes in output wavelength and reduce the effect of output power variations.

4. The swept wavelength laser as claimed in claim 1, wherein the low wavelength noise results in reduced timing indeterminacy of said optical artefact illuminated by said laser source.

5. The swept wavelength laser source as in claim 1, wherein the sweep frequency rate is chosen so that 1/f optical noise in the laser is minimized.

6. The swept wavelength laser source as in claim 5, wherein said sweep frequency rate is chosen by choosing a sufficiently large sweep frequency so that the 1/f noise is not significant in the measurement time of a single sweep.

7. The swept wavelength laser as claimed in claim 1, wherein the sweep frequency rate is chosen so that the bandwidth of a receiver is minimized so that integrated noise on the receiver is minimized.

8. The swept wavelength laser as claimed in claim 7, wherein said sweep frequency rate is chosen by choosing a sufficiently low sweep frequency so that the receiver bandwidth is minimized to reduce the effects of lorentzian noise for the laser which has a flat spectral power density.

9. The swept wavelength laser as claimed in claim 1, wherein the sweep frequency rate is chosen so that FM efficiency is maximized while simultaneously minimizing the power modulation of the output.

10. The swept wavelength laser as claimed in claim 9, wherein the sweep frequency rate is chosen by choosing a sweep frequency where tuning efficiency of the laser source is maximized such that thermal and carrier induced tuning effects produced do not cancel each other.

11. The swept wavelength laser as claimed in claim 1, wherein the laser module is used as a wavelength swept source in an optical system where an approximately linear part of the sweep is used to measure said optical artefact.

12. The swept wavelength laser as claimed in claim 1, wherein said optical artefact is selected from the group consisting of Fabry Perot Etalon, Gas absorption line, Fibre bragg grating, an interferometer, and an optical filter.

13. The swept wavelength laser as claimed in claim 1, wherein a voltage drive signal applied to the laser.

14. The swept wavelength laser as claimed in claim 1, wherein a current drive signal is applied to the laser.

15. The swept wavelength laser as claimed in claim 1, wherein temperature of the laser is controlled to provide adjustment of the laser sweep wavelength.

16. The swept wavelength laser as claimed in claim 1, wherein a bias point of the laser is chosen to minimize the output power variation of the laser.

17. The swept wavelength laser as claimed in claim 1, wherein a reference etalon is used to identify a reference wavelength in the sweep.

18. The swept wavelength laser as claimed in claim 17, where the reference wavelength is selected so that it is in the center of the wavelength sweep.

19. The swept wavelength laser as claimed in claim 17, wherein the module is configured to select a reference wavelength from a test etalon.

20. The swept wavelength laser as claimed in claim 1, wherein output power of the laser is normalized by use of at least one of a variable attenuator and an optical modulator.

21. A method of sweeping a wavelength laser system, comprising in combination:
providing an optical output from a module laser source;
sweeping a wavelength range of the laser source with low wavelength noise at a sweep frequency rate; and
measuring in real-time a single optical artefact over a single wavelength sweep wherein the laser source is optimized for low noise operation.

22. A computer program comprising program instructions for causing a computer to perform the method of claim 21.
